(19) United States
(12) Patent Application Publication
(10) Pub. No.: US 2025/0132371 A1
(43) Pub. Date: Apr. 24, 2025

(54) Manufacturing Apparatus and Manufacturing Method for Electrode Assembly

(71) Applicant: LG Energy Solution, Ltd., Seoul (KR)

(72) Inventors: Jong Seong You, Daejeon (KR); Min Ki Kim, Daejeon (KR)

(73) Assignee: LG Energy Solution, Ltd., Seoul (KR)

(21) Appl. No.: 18/834,266

(22) PCT Filed: Dec. 19, 2023
(86) PCT No.: PCT/KR2023/020972

§ 371 Date: Jul. 30, 2024

(30) Foreign Application Priority Data
Dec. 26, 2022 (KR) 10-2022-0184180

(51) Int. Cl. H01M 10/04

(52) U.S. Cl. CPC H01M 10/0409; H01M 10/0431

(57) ABSTRACT

An apparatus for manufacturing an electrode assembly, includes a mandrel, a first fixing part, and a second fixing part. The mandrel to winds an electrode assembly including a first electrode, a first separator, a second electrode, and a second separator. The first fixing part to fix an outermost periphery of the electrode assembly, and the second fixing part is positioned to be spaced apart from the first fixing part along a circumference of the mandrel and to fix the first and second separators. The first fixing part includes a position adjustment part to adjust a position thereof in accordance with a winding thickness of the electrode assembly. A method comprising the same is also provided.

### CROSS-REFERENCE TO RELATED APPLICATIONS

The present application is a national phase entry under 35 U.S.C. § 371 of International Application No. PCT/KR2023/020972, filed on Dec. 19, 2023, which claims priority from Korean Patent Application No. 10-2022-0184180, filed on Dec. 26, 2022, all of which are incorporated herein by reference.

### TECHNICAL FIELD

The present disclosure relates to an apparatus and method for manufacturing an electrode assembly.

### BACKGROUND ART

In general, a secondary battery refers to a battery that may be charged and discharged, unlike a primary battery that cannot be charged. The secondary batteries are widely used in cutting-edge electronic device fields such as phones, laptop computers, and camcorders.

The stability of the secondary battery may be ensured by performing a stability test that compresses one surface of the secondary battery with a pressing machine and then measures an internal short circuit.

Depending on shapes of battery casings, the secondary batteries are classified into a cylindrical or angular battery in which an electrode assembly is embedded in a cylindrical or angular metal battery casing, and a pouch-type battery in which an electrode assembly is embedded in a pouch-type battery casing provided in the form of a laminated aluminum sheet.

In addition, the electrode assembly embedded in the battery casing is a power generation element configured to be chargeable and dischargeable and having a stacked structure including a positive electrode, a separator, and a negative electrode. The electrode assemblies are classified into a folding-type electrode assembly (jelly-roll-type electrode assembly) made by winding elongated sheet-type positive and negative electrodes coated with an active material in a state in which a separator is interposed between the positive and negative electrodes, and a stack-type electrode assembly made by sequentially stacking a plurality of positive and negative electrodes each having a predetermined size in a state in which separators are interposed between the positive and negative electrodes. Among the electrode assemblies, the advantage of the jelly-roll-type electrode assembly is that the jelly-roll-type electrode assembly is easy to manufacture and has a high energy density per weight.

In the related art, the jelly-roll-type electrode assembly may have a structure in which a positive electrode is shorter in length than a separator, and a negative electrode non-coated portion is wound around an outermost periphery thereof. Further, an apparatus for manufacturing the jelly-roll-type electrode assembly in the related art includes a push roller that pushes an outer periphery of the jelly-roll-type electrode assembly so that the jelly-roll-type electrode assembly is not unwound before an end of the negative electrode non-coated portion is taped.

When the separator of the electrode assembly in the related art is cut, a winding force of the separator is reduced, which reduces a force applied to the positive electrode by the separator.

There may occur a section in which the separator is pressed toward a center of a mandrel, and the wound positive electrode rotates without being fixed to the push roller. In this case, there occurs a problem in that the separator positioned on one surface of the positive electrode is bounced off by the positive electrode by an elastic force that unwinds the positive electrode, and the separator is folded by the elastic force of the positive electrode in a direction in which the positive electrode is positioned.

### SUMMARY

### Technical Problem

An aspect of the present invention has been made in an effort to solve the above-mentioned problem in the related art, and an object of the present invention is to provide an apparatus and method for manufacturing an electrode assembly, which is capable of suppressing an elastic force of a positive electrode until a separator is completely wound, thereby preventing the separator from being folded.

### Technical Solution

An embodiment of the present invention provides an apparatus for manufacturing an electrode assembly, the apparatus including: a mandrel configured to wind an electrode assembly including a first electrode, a first separator, a second electrode, and a second separator; a first fixing part configured to fix an outermost periphery of the electrode assembly; and a second fixing part positioned to be spaced apart from the first fixing part along a circumference of the mandrel and configured to fix the first and second separators, in which the first fixing part includes a position adjustment part configured to adjust a position thereof in accordance with a winding thickness of the electrode assembly.

The embodiment of the present invention provides the apparatus for manufacturing an electrode assembly, in which the first fixing part includes: a support part; and a fixing roller provided to be in contact with the outermost periphery of the electrode assembly and configured to fix the electrode assembly, and in which the position adjustment part is positioned between the support part and the fixing roller.

The embodiment of the present invention provides the apparatus for manufacturing an electrode assembly, in which the first fixing part further includes a connection part configured to connect the support part and the fixing roller, and in which the connection part includes: a first connection part having one end coupled to the support part; a second connection part having one end coupled to the fixing roller, and the other end coupled to the first connection part, and a rotary part configured to enable the second connection part to be moved by the position adjustment part.

The embodiment of the present invention provides the apparatus for manufacturing an electrode assembly further including: a movement rail coupled to the first fixing part and configured to move the first fixing part.

The embodiment of the present invention provides the apparatus for manufacturing an electrode assembly further including: a cutting part configured to cut the first and second separators, in which the cutting part cuts the first and second separators so that a length of each of the first and second separators is longer than a length of the second electrode.

The embodiment of the present invention provides the apparatus for manufacturing an electrode assembly, in which the first fixing part fixes the electrode assembly wound around the mandrel before winding end portions of the first and second separators are fixed to the second fixing part.

Another embodiment of the present invention provides a method of manufacturing an electrode assembly, the method including: a winding step of manufacturing an electrode assembly by winding a first electrode, a first separator, a second electrode, and a second separator around the mandrel; a first fixing step of fixing an outermost periphery of the electrode assembly to a first fixing part; and a second fixing step of fixing ends of the first and second separators to a second fixing part by rotating the mandrel.

Another embodiment of the present invention provides the method of manufacturing an electrode assembly, in which in the first fixing step, the first fixing part is moved in a direction in which the mandrel is positioned, and the first fixing part and the wound object are in contact with each other.

Another embodiment of the present invention provides the method of manufacturing an electrode assembly, in which the first and second separators are fixed by the first fixing part until winding distal ends are fixed to the second fixing part.

Another embodiment of the present invention provides the method of manufacturing an electrode assembly, in which the first fixing step includes a cutting step of cutting the first and second separators by using a cutting part, and in which the cutting part cuts the first and second separators so that a length of each of the first and second separators is longer than a length of the positive electrode.

### ADVANTAGEOUS EFFECTS

According to the apparatus method for manufacturing an electrode assembly according to the embodiment of the present invention, the first fixing part is provided to fix the positive electrode until the end of the separator is fixed to the second fixing part, thereby suppressing an elastic force of the positive electrode, preventing the separator from being folded, and reducing a defect of the secondary battery.

### BRIEF DESCRIPTION OF DRAWINGS

FIG. 1 is a cross-sectional view illustrating an apparatus for manufacturing an electrode assembly according to an embodiment of the present invention.

FIG. 2 is a cross-sectional view illustrating a first fixing part according to the embodiment of the present invention.

FIG. 3 is a cross-sectional view illustrating a first fixing part according to another embodiment of the present invention.

FIG. 4 is a cross-sectional view illustrating a first fixing part according to still another embodiment of the present invention.

### REFERENCE NUMERALS AND SYMBOLS

100: Apparatus for manufacturing electrode assembly
1: First electrode, negative electrode
2: Second electrode, positive electrode
3: First separator
4: Second separator
10: Mandrel
20: First fixing part
21: Support part
22: Connection part
22a: First connection part
22b: Second connection part
23: Fixing roller
24: Position adjustment part
30: Second fixing part
C: Rotary shaft

### DETAILED DESCRIPTION

The detailed description of embodiments of the present invention is provided to completely explain the present invention to a person with ordinary skill in the art. Throughout the specification, unless explicitly described to the contrary, when one component “comprises (includes)” another component or “characterized by” having a certain structure and a certain shape, this means that other components, structures, and shapes may be included without being excluded.

The present invention may be variously modified and may have various embodiments, and specific embodiments will be described in detail in the detailed description. However, the description of the embodiments is not intended to limit the contents of the present invention, but it should be understood that the present invention is to cover all modifications, equivalents and alternatives falling within the spirit and technical scope of the present invention.

Hereinafter, the present invention will be described in detail with reference to the drawings. However, the drawings are intended to illustratively describe the present invention, and the scope of the present invention is not limited by the drawings.

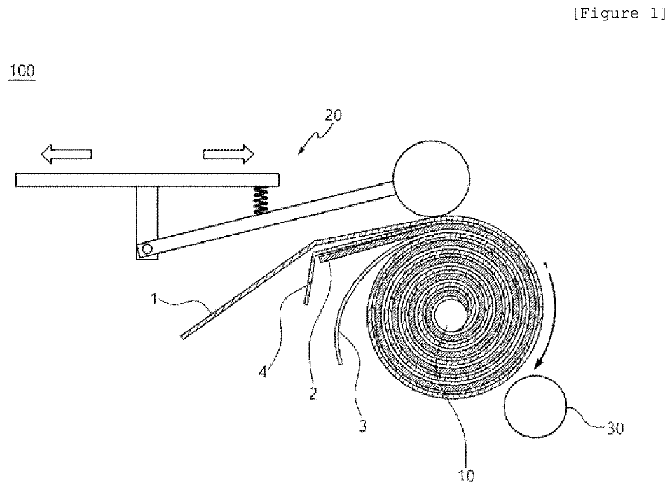

FIG. 1 is a cross-sectional view illustrating an apparatus 100 for manufacturing an electrode assembly according to an embodiment of the present invention. The apparatus 100 for manufacturing an electrode assembly includes a mandrel 10, a cutting part (not illustrated), a first fixing part 20, and a second fixing part 30.

The mandrel 10 serves to wind a first electrode 1, a first separator 3, a second electrode 2, and a second separator 4. In the embodiment, the mandrel 10 may have a cylindrical shape or a rod shape. A groove having a predetermined length may be provided in a surface of the mandrel 10 in a direction toward a center of the mandrel 10, and winding-start end portions of the first separator 3 and second separator 4 may be fixed to the groove.

The mandrel 10 may rotate clockwise or counterclockwise to wind the first electrode 1, the first separator 3, the second electrode 2, and the second separator 4. The first electrode 1, the first separator 3, the second electrode 2, and the second separator 4, which are wound around the mandrel 10, may be precursors or wound objects of an electrode assembly. The precursor of the electrode assembly may have a jelly-roll structure.

The apparatus 100 for manufacturing an electrode assembly according to an embodiment of the present invention may further include a drive part (not illustrated) configured to rotate the mandrel 10. The drive part may be coupled to one side of the mandrel 10 and provide a rotational force to the mandrel 10.

In the case of the electrode assembly according to an embodiment of the present invention, the first electrode 1, the first separator 3, the second electrode 2, and the second separator 4 may be wound in this order, and the first electrode 1 or a non-coated portion of the first electrode may be wound around an outermost periphery of the electrode assembly. the embodiment, the first electrode 1 is a negative electrode, and the non-coated portion of the first electrode is a negative electrode non-coated portion to be described below. That is, the electrode assembly according to an embodiment of the present invention includes a structure in which a negative electrode current collector is wound around an outermost periphery thereof. Further, in an embodiment of the present invention, the precursor of the electrode assembly means a state made before the first electrode 1, the first separator 3, the second electrode 2, and the second separator 4 are completely wound. The electrode assembly means a state in which the first electrode 1, the first separator 3, the second electrode 2, and the second separator 4 are completely wound, and a tape is attached to a winding end portion of the negative electrode non-coated portion.

The electrode assembly refers to a power generation element including the second electrode 2, the first electrode 1, and the separators 3 and 4 positioned between the second electrode 2 and the first electrode 1 and configured to be chargeable and dischargeable.

The second electrode 2, i.e., the positive electrode may include a positive electrode current collector, a positive electrode active material portion, and a positive electrode non-coated portion. The positive electrode current collector may include a thin metal plate excellent in conductivity, e.g., an aluminum (Al) foil.

The positive electrode 2 is made by coating any one of or opposite surfaces of the positive electrode current collector with a positive electrode active material. A region in which the positive electrode active material is applied is the positive electrode active material portion, and a region in which no positive electrode active material is applied is the positive electrode non-coated portion. Because no positive electrode active material layer is applied onto the positive electrode non-coated portion, the positive electrode non-coated portion may be joined to a first electrode tab.

The positive electrode active material may include lithium cobalt oxide having high working voltage and excellent capacity characteristics, lithium nickel oxide having high reversible capacity and used to easily implement a high-capacity battery, lithium nickel cobalt oxide made by substituting a part of nickel with cobalt, lithium nickel cobalt metal oxide made by substituting a part of nickel with manganese, cobalt, or aluminum, lithium manganese-based oxide having excellent thermal stability and made with low costs, and lithium iron phosphate having excellent stability.

The first electrode, i.e., the negative electrode 1 may include a negative electrode current collector, a negative electrode active material portion, and a negative electrode non-coated portion. The negative electrode current collector may include a thin metal plate excellent in conductivity, e.g., a copper (Cu) or nickel (Ni) foil.

The negative electrode 1 is made by coating one surface or two opposite surfaces of the negative electrode current collector with a negative electrode active material. The negative electrode active material portion is formed by being coated with a negative electrode active material or applying the negative electrode active material. The negative electrode non-coated portion is a region in which no negative electrode active material is applied or a region that is not coated with the negative electrode active material. The negative electrode non-coated portion is a region in which the negative electrode current collector is exposed. Because no negative electrode active material is applied onto the negative electrode non-coated portion, the negative electrode non-coated portion may be joined to a second electrode tab.

For example, the negative electrode active material may be crystalline carbon, amorphous carbon, carbon composite, carbon material such as carbon fiber, lithium metal, lithium alloy, or the like. In this case, for example, the negative electrode active material may further include non-graphite-based SiO (silica), SiC (silicon carbide), or the like to design a high capacity.

The first and second electrode tabs may serve to transfer electrons, which are collected on the current collector, to an external circuit and protrude in directions in which the first and second electrode tabs face each other with respect to the electrode assembly having the jelly-roll structure.

The separators 3 and 4 may each serve to prevent an internal short circuit that may be caused by contact between the positive electrode 2 and the negative electrode 1. The separators 3 and 4 may each include a porous material so that ions move smoothly between the electrodes.

In the embodiment, the separators 3 and 4 may each include a base layer made of a porous material. For example, the base layer may include any one selected from a group consisting of polyethylene (PE), polystyrene (PS), polypropylene (PP), and a copolymer of polyethylene (PE) and polypropylene (PP).

In another embodiment, the separators 3 and 4 may each include a safety reinforced separator (SRS). That is, the separators 3 and 4 may include the base layer made of a porous material, and a coating layer made by coating the base layer with a slurry mixture made by mixing inorganic particles and a binder polymer. In particular, the coating layer has a porous structure including ceramic particles and included in a base of the separator and has a uniform porous structure formed by empty spaces (interstitial volume) between the ceramic particles which are components of the active layer.

The coating layer may include ceramic particles including at least one selected from a group consisting of alumina, silica, TiO₂, SiC, and MgAl₂O₄. The coating layer included as described above may improve the safety of the electrode assembly. Further, the coating layer may further include lithium salt.

The cutting part cuts the first separator 3 and second separator 4. The cutting part may cut the first separator 3 and second separator 4 so that a length of each of the first separator 3 and second separator 4 is longer than a length of the negative electrode active material portion and a length of the positive electrode active material portion. In this case, the length means a distance between two opposite ends of the negative electrode 1, the first separator 3, the positive electrode 2, and the second separator 4 positioned in a direction in which the negative electrode 1, the first separator 3, the positive electrode 2, and the second separator 4 move to the mandrel 10.

The type and shape of the cutting part are not specially limited as long as the cutting part may cut the first separator 3 and second separator 4.

The first fixing part 20 may fix the outermost

periphery of the electrode assembly. Specifically, the first fixing part 20 is in contact with the outermost periphery of the wound object and fixes the outermost periphery of the wound object to maintain a state in which the wound object is wound around the mandrel 10. In other words, the first fixing part 20 may fix a wound state of the wound object by pressing the outermost periphery of the wound object toward the center of the mandrel 10. The negative electrode, particularly the negative electrode non-coated portion of the wound object may be in contact with the first fixing part 20.

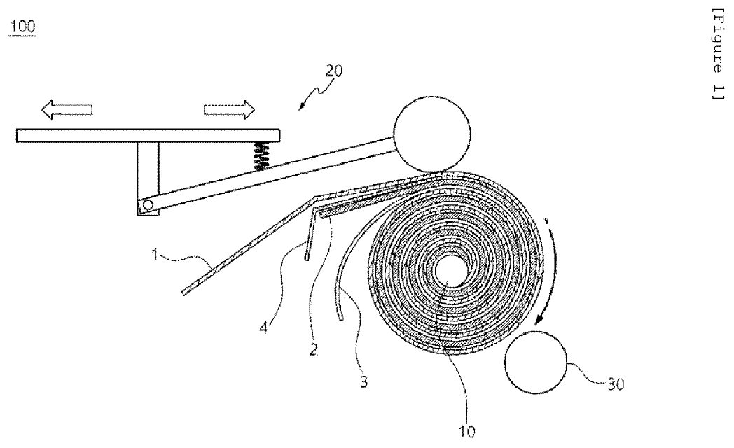

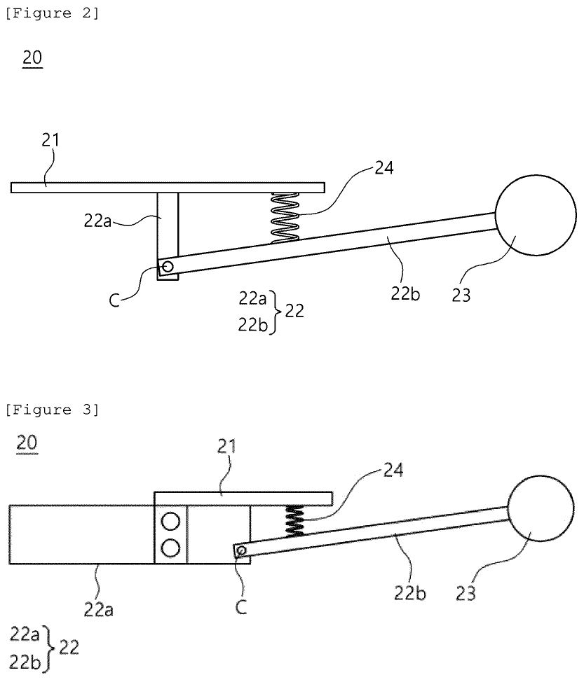

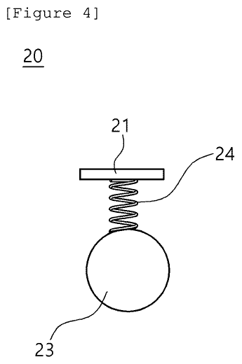

FIG. 2 is a cross-sectional view illustrating the first fixing part 20 according to the embodiment of the present invention, FIG. 3 is a cross-sectional view illustrating the first fixing part 20 according to another embodiment of the present invention, and FIG. 4 is a cross-sectional view illustrating the first fixing part 20 according to still another embodiment of the present invention.

In the embodiment, the first fixing part 20 includes a support part 21, a fixing roller 23, and a position adjustment part 24. In another embodiment and still another embodiment, the first fixing part 20 includes the support part 21, a connection part 22, the fixing roller 23, and the position adjustment part 24.

The support part 21 is fixed to another component, a wall surface, a ground surface, or the like and supports the first fixing part 20.

The connection part 22 connects the fixing roller 23 and the support part 21 that will be described below. The connection part 22 is positioned on one surface of the support part 21. Further, the connection part 22 may include a first connection part 22a having one end coupled to the support part 21, a second connection part 22b having one end coupled to the fixing roller 23 and the other end coupled to the first connection part 22a. A rotary part C is configured to enable the second connection part 22b to be moved by the position adjustment part 24.

For example, the first connection part 22a may extend in a direction perpendicular to the support part 21. In other words, the first connection part 22a may extend while defining a right angle with respect to one surface of the support part 21.

Alternatively, the first connection part 22a may serve to support the second connection part 22b. The first connection part 22a may be provided on one surface of the support part 21, positioned in parallel with the support part 21, and extend in a direction opposite to a direction in which the position adjustment part 24 is positioned. In this case, the first connection part 22a may partially overlap the support part 21, and the support part 21 and the first connection part 22a may be coupled by means of a hinge.

The second connection part 22b may be positioned between the fixing roller 23 and the first connection part 22a and rotated or moved by the position adjustment part 24.

The connection part 22 of the first fixing part 20 according to another embodiment may extend in the direction perpendicular to the support part 21. In this case, the second connection part 22b may have an angle of 180° or less with respect to the first connection part 22a. In particular, an angle defined between the second connection part 22b and the first connection part 22a may be 10° to 150°, more particularly 30° to 120°.

In case that the connection part 22 extends in parallel with the support part 21 according to still another embodiment, the fixing roller 23, (i.e., the second connection part 22b) may have an angle of 90° or less with respect to the support part 21 or the first connection part 22a. In particular, an angle defined between the second connection part 22b and the support part 21 or between the second connection part 22b and the first connection part 22a may be 10° to 90°, more particularly 30° to 90°.

The fixing roller 23 may come into contact with the outermost periphery of the wound object wound around the mandrel 10 and fix the wound object before the separators 3 and 4 are cut or at the same time when the separators 3 and 4 are cut. That is, the fixing roller 23 may press and fix winding distal ends of the positive electrode 2 and the separators 3 and 4 of the wound object.

The first fixing part 20 according to an embodiment of the present invention fixes a part of the positive electrode 2, i.e., the winding end portion of the positive electrode 2 before the separators 3 and 4 are cut or at the same time when the separators 3 and 4 are cut. Therefore, it is possible to prevent a problem in that the separators 3 and 4 are bounced off by elasticity by the positive electrode 2 while the separators 3 and 4 are cut, which damages the separators 3 and 4 or folds the separators 3 and 4.

The fixing roller 23 moves in the direction in which the mandrel 10 is positioned, and the fixing roller 23 comes into contact with a part of the wound object wound around the mandrel 10 and presses the wound object. In this case, the wound object has a structure in which the negative electrode non-coated portion is not wound around the outermost periphery of the wound object after the negative electrode 1, the first separator 3, the positive electrode 2, and the second separator 4 are wound multiple times. Therefore, even though the thickness of the wound object increases as the negative electrode non-coated portion is wound, the fixing roller 23 may be rotated by a rotary shaft and accommodate the change in thickness of the wound object.

The position adjustment part 24 is positioned between one surface of the fixing roller 23 and one surface of the support part 21 and provides an elastic force to the fixing roller 23. The position adjustment part 24 may include a material having a restoring force. For example, the position adjustment part 24 may include an elastic member, and the elastic member may include any one of silicone, rubber, and a spring.

The fixing roller 23 may press the wound object with the restoring force of the position adjustment part 24. In the embodiment, the elastic force or restoring force of the position adjustment part 24 may increase as the angle defined between the fixing roller 23 and the connection part 22 decreases. When the elastic force or restoring force of the position adjustment part 24 pushes the support part 21 and the fixing roller 23, the fixing roller 23 may press and fix the wound object by receiving the elastic force from the position adjustment part 24 in the direction in which the wound object is positioned.

The first fixing part 20 may move in a first direction in which the mandrel 10 is positioned and a second direction opposite to the first direction. Therefore, the apparatus 100 for manufacturing an electrode assembly according to an embodiment of the present invention may further include a movement rail (not illustrated) coupled to the first fixing part 20 and configured to move the first fixing part 20 in the first and second directions.

The second fixing part 30 is positioned to be spaced apart from the first fixing part 20 along a circumference of the mandrel 10 and fixes the ends of the first separator 3 and second separator 4. The second fixing part 30 may fix the ends of the first separator 3 and second separator 4 by coming into contact with the first fixing part 20 or coming into contact with a part of the wound object that is not fixed by the first fixing part 20.

The second fixing part 30 may move in a third direction in which the mandrel 10 is positioned and a fourth direction opposite to the third direction. Therefore, the apparatus 100 for manufacturing an electrode assembly may further include a movement part (not illustrated) configured to move the second fixing part 30 in the third and fourth directions. The shape of the movement part is not specially limited as long as the movement part may move the second fixing part 30 in the third and fourth directions.

A length of each of the first separators 3 and second separator 4 of the wound object according to an embodiment of the present invention may be longer than a length of the positive electrode 2. In other words, a first part, on which the positive electrode 2 is positioned, and a second part, on which the positive electrode 2 is not positioned, may be included between the first separator 3 and second separator 4. Further, a length of the second part may correspond to half the circumference of the wound object.

For example, a circumference of the wound object, around which the first separator 3 and second separator 4 and the winding distal end of the negative electrode non-coated portion are wound, may be 50 to 80 mm. In this case, the length of the second part may be 25 to 40 mm, i.e., half the circumference of the wound object.

Further, in the apparatus 100 for manufacturing an electrode assembly according to an embodiment of the present invention, a spacing distance between the first fixing part 20 and the second fixing part 30 may correspond to the length of the second part of the first separator 3 and second separator 4. That is, the spacing distance between the first fixing part 20 and the second fixing part 30 may be a length corresponding to half the circumference of the wound object.

Because the spacing distance between the first fixing part 20 and the second fixing part 30 corresponds to the length of the second part of the first separator 3 and second separator 4, the first fixing part 20 may press and fix the negative electrode non-coated portion, the first separator 3, the positive electrode 2, and the second separator 4 before the ends of the first separator 3 and second separator 4, i.e., the winding distal ends of the first separator 3 and second separator 4 are fixed to the second fixing part 30.

Therefore, a free rotation section of the positive electrode 2 is not reduced or generated until the first separator 3 and second separator 4 and the negative electrode non-coated portion are completely wound, such that the elastic force of the positive electrode 2 may be suppressed, which may prevent a problem in that the first separator 3 and second separator 4 are bounced off by the positive electrode 2 by the elastic force of the positive electrode 2 and the first separator 3 and second separator 4 are folded. In this case, the free rotation section means a section from a time point at which the first separator 3 and second separator 4 are cut to a time point before the positive electrode 2 is fixed by the first fixing part 20 or the second fixing part 30.

The fixing roller 23 and the second fixing part 30 may include a material that does not chemically react with the negative electrode non-coated portion. Further, the fixing roller 23 and the second fixing part 30 may include an elastic material. For example, the fixing roller 23 and the second fixing part 30 may include any one or more of urethane, silicone, carbon, aluminum, metal, and polymer.

Further, in case that the fixing roller 23 and

the second fixing part 30 are made of metal, a metal surface may be subjected to coating, plating, or physical-chemical surface treatment, such that the fixing roller 23 and the second fixing part 30 do not chemically react with the negative electrode non-coated portion.

A method of manufacturing an electrode assembly according to an embodiment of the present invention includes a winding step S10 of manufacturing the wound object by winding the positive electrode, the first separator, the negative electrode, and the second separator around the mandrel, a first fixing step S20 of fixing a part of the wound object by the first fixing part and cutting the first and second separators, and a second fixing step S30 of fixing the ends of the first and second separators to the second fixing part by rotating the mandrel.

The winding step S10 may include a separator fixing step S11 of fixing starting ends of the first and second separators to the mandrel, a negative electrode supply step S12 of supplying the negative electrode to one surface of the second separator, and a positive electrode supply step S13 of supplying the positive electrode to one surface of the first separator.

The winding step S10 may supply the negative electrode and the positive electrode while winding the separator by rotating the mandrel after the separator fixing step S11 or wind the positive electrode, the first separator, the negative electrode, and the second separator by rotating the mandrel after stacking the positive electrode, the first separator, the negative electrode, and the second separator.

The first fixing step S20 may include a step S21 of fixing the wound object by bringing the first fixing part into contact with the wound object by moving the first fixing part in the direction in which the mandrel is positioned, and a step S22 of cutting the first and second separators.

The step S22 of cutting the first and second separators may cut the first and second separators so that the length of each of the first and second separators is longer than the length of the positive electrode. That is, the first and second separators may extend along the circumference of the wound object at the position corresponding to the winding distal end of the positive electrode. The negative electrode and the positive electrode may not be positioned between the first separator and the second separator of the extended portions.

In this case, the extended portions of the first and second separators may have a length corresponding to the half the circumference of the wound object. The first and second separators may be fixed by the first fixing part until the winding distal end is fixed to the second fixing part.

For example, when the winding distal end of the positive electrode is positioned at a rear end of the second fixing part, the first fixing part may move to fix the wound object. Further, when the first and second separators are cut by the preset lengths of the first and second separators, the elastic force of the positive electrode may be reduced by the pressing force of the first fixing part for fixing the first and second separators until the winding distal ends of the first and second separators pass the first fixing part and are fixed to the second fixing part by the rotation of the mandrel.

Further, in case that the positive electrode has the free rotation section during the process of cutting the circumference of the wound object, the separator may be folded by the elastic force of the positive electrode. In this case, the folded portion of the separator may be unfolded together with the winding by the rotation of the mandrel and the pressing force of the first fixing part for pressing the wound object.

The description of the apparatus for manufacturing an electrode assembly may be applied to the description of the method of manufacturing an electrode assembly according to an embodiment of the present invention.

While the present invention has been described above with reference to the exemplary embodiments, it may be understood by those skilled in the art that the present invention may be variously modified and changed without departing from the spirit and scope of the present invention disclosed in the claims.

1. An apparatus for manufacturing an electrode assembly, the apparatus comprising:
a mandrel configured to wind an electrode assembly comprising a first electrode, a first separator, a second electrode, and a second separator;
a first fixing part configured to fix an outermost periphery of the electrode assembly; and
a second fixing part spaced apart from the first fixing part along a circumference of the mandrel, the second fixing part being configured to fix the first and second separators,
wherein the first fixing part comprises a position adjustment part configured to adjust a position thereof with based on a winding thickness of the electrode assembly.

2. The apparatus of claim 1, wherein the first fixing part comprises:
a support part; and
a fixing roller configured to contact the outermost periphery of the electrode assembly and configured to fix the electrode assembly, and
wherein the position adjustment part is positioned between the support part and the fixing roller.

3. The apparatus of claim 2, wherein the first fixing part further comprises a connection part coupling the support part and the fixing roller, and wherein the connection part comprises:
a first connection part having one end coupled to the support part;
a second connection part having one end coupled to the fixing roller, and the other end coupled to the first connection part, the second connection part including a rotary part enabling the second connection part to be moved by the position adjustment part.

4. The apparatus of claim 1, further comprising:
a movement rail coupled to the first fixing part and configured to move the first fixing part.

5. The apparatus of claim 1, further comprising:
a cutting part configured to cut the first and second separators,
wherein the cutting part is configured to cuts the first and second separators so that a length of each of the first and second separators is longer than a length of the second electrode.

6. The apparatus of claim 1, wherein the first fixing part is configured to fixes the electrode assembly wound around the mandrel before winding end portions of each of the first and second separators are fixed to the second fixing part.

7. A method of manufacturing an electrode assembly, the method comprising:
winding a first electrode, a first separator, a second electrode, and a second separator around a mandrel to form the electrode assembly;
fixing an outermost periphery of the electrode assembly to a first fixing part in a first fixing; and
fixing ends of the first and second separators to a second fixing part by rotating the mandrel in a second fixing.

8. The method of claim 7, wherein in the first fixing-step, the first fixing part is moved in a direction toward the mandrel to contact the first fixing part and the electrode assembly being in a wound state.

9. The method of claim 7, wherein the ends of the first and second separators are fixed by the first fixing part until winding end portions of each of the first and second separators are fixed to the second fixing part.

10. The method of claim 7, wherein the first fixing cutting the first and second separators with a cutting part, and
wherein the cutting part cuts the first and second separators so that a length of each of the first and second separators is longer than a length of the second electrode.
